(19) United States
(12) Patent Application Publication
(10) Pub. No.: US 2006/0145625 A1
(43) Pub. Date: Jul. 6, 2006

(54) Metal halide lamp

(76) Inventors: Nobuyoshi Takeuchi, Ibaraki-shi (JP); Yoshiharu Nishiura, Ohtsu-shi (JP)

Correspondence Address: SNELL & WILMER L.L.P., 600 ANTON BOULEVARD, SUITE 1400, COSTA MESA, CA, 92626, US

(21) Appl. No.: 10/536,704

(22) PCT Filed: Sep. 6, 2004
(86) PCT No.: PCT/JP04/13259

§ 371 Date: May 27, 2005

(30) Foreign Application Priority Data
Sep. 22, 2003 (JP) 2003-330534

(51) Int. Cl. H01J 17/16; H01J 61/30; H01J 17/20

(52) U.S. Cl. 313/634; 313/573; 313/493

(57) ABSTRACT

A metal halide lamp has an arc tube that includes: a pair of electrode structures, each of which has an electrode at a tip; a main tube part made of polycrystalline alumina ceramic, and containing a discharge space in which the electrodes of the electrode structures are located to oppose each other; and a pair of thin tube parts that connect from the main tube part and are sealed by respective sealing members with the electrode structures inserted therein, where 20≦WL≦50, EL/Di≧2.0, and 0.5≦G≦5.0 are satisfied where tube wall loading of the arc tube is WL(W/cm²), a distance between the electrodes is EL(mm), an inner diameter of the main tube part is Di (mm), and a crystal grain diameter of the polycrystalline alumina ceramic is G(μm)

### FIELD OF INVENTION

The present invention relates to a metal halide lamp.

### BACKGROUND ART

Metal halide lamps having been developed in recent years are widely used for interior lighting especially in commercial establishments such as in shops.

Conventionally, most arc tubes of metal halide lamps were made of quartz. In recent years, however, arc tubes made of ceramic materials have been actively developed. Quartz arc tubes are heat resistant up to about 1000° C., whereas ceramic arc tubes are heat resistant up to about 1200° C. or more. Therefore if a metal halide lamp has a ceramic arc tube, it has higher tube wall loading, and achieves high efficiency and high color rendering. A common ceramic material is polycrystalline alumina ceramic (Al₂O₃) (hereinafter occasionally referred to as “alumina”) whose transmittance is high as 90% or more, and so is instrumental in improving lamp efficiency.

Meanwhile, a Japanese Laid-open patent application No. 2002-536786 proposes a slim arc tube for the purpose of obtaining high efficiency. The main reason why such a slim arc tube is instrumental in obtaining high efficiency is considered to be as follows. As the distance between the electrodes becomes long due to the elongated form of the arc tube, the chances of collision between electrons and luminous metals will increase, thereby increasing the amount of emission spectrum. In addition, as the arc tube becomes thinner, self-absorption of luminous metals is restrained, thereby efficiently outputting the emission spectrum towards outside the arc tube.

However, in such a metal halide lamp having a slim shape, the distance between the inner wall of the arc tube and the arc becomes short, subjecting the arc tube to a high temperature. More specifically, an arc tube has a heat cycle in which the arc tube is heated to a high temperature and is cooled to a room temperature due to an on/off cycle of a lamp. If an arc tube becomes very slim as in the above, it will be heated to a very high temperature and then cooled, i.e. subjected to a high heat before being cooled. As a result, the arc tube will be subjected to a large thermal shock. A conventional arc tube having a comparatively large inner diameter will not be subjected to such a high heat during the lamp's illumination, and so it is very rare that a crack is caused due to a thermal shock. However if an arc tube is made to be slim for the purpose of providing a high-efficiency lamp, it is apt to crack incident to an extreme thermal shock explained above, thereby shortening a lamp life.

The present invention has been conceived in view of such a problem, and has an object of providing a metal halide lamp that does not crack, as well as having high efficiency and a long life.

### DISCLOSURE OF INVENTION

In view of the stated problems, the present invention provides a metal halide lamp having an arc tube that includes: a pair of electrode structures, each of which has an electrode at a tip; a main tube part made of polycrystalline alumina ceramic, and containing a discharge space in which the electrodes of the electrode structures are located to oppose each other; and a pair of thin tube parts that connect from the main tube part and are sealed by respective sealing members with the electrode structures inserted therein, where 20≦WL≦50, EL/Di≧2.0, and 0.5≦G≦5.0 are satisfied where tube wall loading of the arc tube is WL(W/cm²), a distance between the electrodes is EL(mm), an inner diameter of the main tube part is Di (mm), and a crystal grain diameter of the polycrystalline alumina ceramic is G(μm). Here, the tube wall loading is an arc discharge input per unit surface area of the inner wall of the main tube part between the electrodes. In addition, “crystal grain diameter” used in the present description means an average crystal grain diameter for polycrystalline alumina ceramic grains. A concrete calculation method is detailed later.

Furthermore, it is preferable that the crystal grain diameter G(μm) of the polycrystalline alumina ceramic satisfies 0.5≦G≦1.5.

In the stated construction, it is preferable that the inner diameter Di(mm) of the main tube part satisfies 2.0≦Di≦10.0, for the purpose of reducing self-absorption.

In addition, it is preferable that the polycrystalline alumina ceramic contains magnesium oxide (MgO) of 200 ppm or below.

Moreover, so as to generate a high-efficiency lamp, it is preferable that the polycrystalline alumina ceramic has transmittance of 94% or more.

With the stated constructions, as a material of the main tube part, the crystal grain diameter of polycrystalline alumina ceramic is adjusted to 5 μm or smaller, which is smaller than conventional cases. Accordingly, the main tube part has enhanced resistance against thermal shocks. As a result, when the arc tube is heated to a higher temperature than conventional cases due to slimness of the arc tube, a crack incident to a great thermal shock hardly occurs for the main tube part. If a metal halide lamp is produced using such a main tube part, it will have a long life as well as high luminous efficiency.

Please note that it is confirmed that cracks are more effectively restrained by adjusting the crystal rain diameter G (μm) of polycrystalline alumina ceramic to be in a range of 0.5 to 1.5, inclusive.

In addition polycrystalline alumina ceramic having low reactivity with the enclosure is obtainable if alumina powders, to which MgO of 200 ppm or below is added, are sintered. If a lamp has a main tube part made of such polycrystalline alumina ceramic, the lamp is able to sustain a favorable luminous flux maintenance factor for a long time. This is instrumental in providing a metal halide lamp having a long life.

Furthermore, if alumina powders to which MgO is added are sintered using a tungsten furnace, and at atmospheric pressure (i.e. in hydrogen atmosphere) or in a vacuum, resulting polycrystalline alumina ceramic will gain transmittance of 94% or more. A metal halide lamp, having a main tube part made of such polycrystalline alumina ceramic, will be efficient.

### BRIEF DESCRIPTION OF THE DRAWINGS

FIG. 1 is a diagram showing an entire structure of a metal halide lamp relating to an embodiment of the present invention.

FIG. 2 is a sectional diagram showing a structure of an arc tube relating to the embodiment.

FIG. 3 is data showing a relationship between the luminous flux maintenance factor and the amount of MgO added.

FIG. 4 is data showing a relationship between the crystal grain diameter and the crack probability, when the tube wall loading is 35 W/cm². Specifically in FIG. 4, (1) shows a case where the main tube part's inner diameter is 2.0 mm, (2) shows a case where the main tube part's inner diameter is 3.5 mm, (3) shows a case where the main tube part's inner diameter is 5.0 mm, (4) shows a case where the main tube part's inner diameter is 7.0 mm, and (5) shows a case where the main tube part's inner diameter is 10.0 mm.

FIG. 5 is data showing a relationship between the crystal grain diameter and the crack probability, when the tube wall loading is 45 W/cm². Specifically in FIG. 5, (1) shows a case where the main tube part's inner diameter is 2.0 mm, (2) shows a case where the main tube part's inner diameter is 3.5 mm, (3) shows a case where the main tube part's inner diameter is 5.0 mm, (4) shows a case where the main tube part's inner diameter is 7.0 mm, and (5) shows a case where the main tube part's inner diameter is 10.0 mm.

### BEST MODE FOR CARRYING OUT THE INVENTION

As follows, an embodiment of a metal halide lamp relating to the present invention is described by referring to the drawings.

1. Structure of Metal Halide Lamp

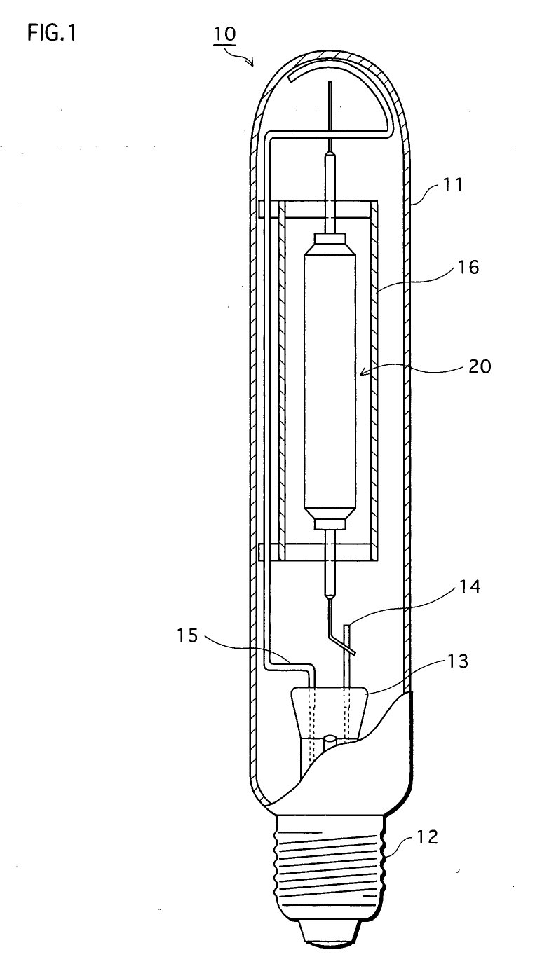

The following details an embodiment of a metal halide lamp relating to the present invention by referring to the drawings. First, an entire structure of a metal halide lamp relating to the present embodiment is described by referring to FIG. 1. FIG. 1 is a diagram showing a structure of a metal halide lamp 10 relating to the present embodiment. In FIG. 1, an outer-tube glass bulb 11 is partly cut away to show inside the lamp.

As FIG. 1 shows, in the metal halide lamp 10, an outer-tube glass bulb 11 is provided with an E-type base 12. Inside the outer-tube glass bulb 11, the arc tube 20 is supported by power-supply stem wires 14 and 15, the stem wires 14 and 15 extending from a glass stem 13.

A quartz shield tube 16 surrounds a side surface of the arc tube 20, so as to protect the outer-tube glass bulb 11 from being broken in case when the arc tube 20 is broken, for example. Nitrogen of 46.5 kPa is enclosed in the outer-tube glass bulb 11, for creating insulation between the stem wires 14 and 15 so as to prevent discharge within the outer-tube glass bulb 11. The outer-tube glass bulb 11 also thermally insulates the arc tube 20, prevents oxidation of the stem wires, and soon. Next, an embodiment of the arc tube 20 provided for the metal halide lamp 10 is described.

2. Structure of Arc Tube

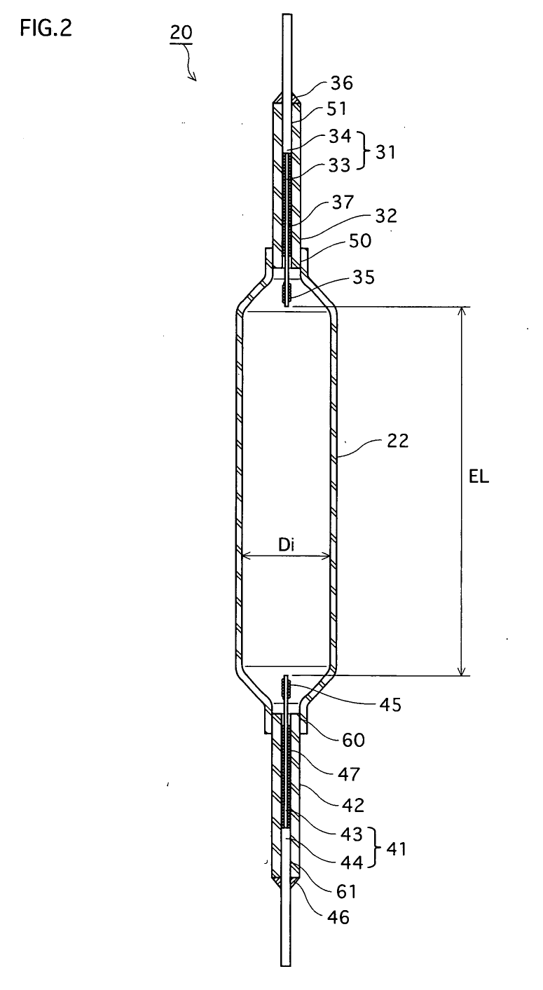

The following describes a structure of the arc tube 20 relating of the present embodiment, by referring to FIG. 2. FIG. 2 is a sectional view showing the structure of the arc tube 20. The arc tube 20 is made of: a main tube part 22 that contains a discharge space; thin tube parts 32 and 42 provided at respective ends of the main tube part 22; and electrode structures 31 and 41.

The main tube part 22 is in a substantially cylindrical tubular shape with an internal diameter of “Di”. The end portions of the main tube part 22 taper off towards the respective openings.

The thin tube parts 32 and 42 are respectively inserted to the openings of the main tube part 22. A connected part 50 between the thin tube part 32 and the main tube part 22 is sealed airtight by being fired. Likewise, a connected part 60 between the thin tube part 42 and the main tube part 22 is sealed airtight by being fired.

The electrode structure 31 is formed by electrically connecting an electrode part 33 and a power supply part 34. Likewise, the electrode structure 41 is formed by electrically connecting an electrode part 43 and a power supply part 44.

The electrode part 33 has a tungsten rod and a tungsten coil 35 wound around a tip of the tungsten rod. The electrode part 43 also has the identical structure.

The electrode structures 31 and 41 are respectively inserted into the thin tube parts 32 and 42, so that the tips of the electrode parts 33 and 34 will oppose each other at a predetermined distance EL in the discharge space of the main tube part 22. The thin tube parts 32 and 42 are sealed airtight by means of frits 36 and 46, respectively, the frits having been flown to cover the entire power supply parts 34 and 44 of the electrode structures 31 and 41. The frits 36 and 46 also prevent the power supply parts 34 and 44 from being eroded by halogen while the lamp is lit.

The molybdenum coils are wound around the tungsten rods of the electrode parts 33 and 43, respectively, for the purpose of preventing luminous metals sealed in the discharge space from entering into the thin tube parts 32 and 42. Once the luminous metals enter deep into the thin tube parts 32 and 42 from the main tube part 22, the luminous metals cannot easily return back to the discharge space of the main tube part 22. As a result, the discharge space will lose a certain amount of the luminous metals. As the change in the amount of the luminous metals, the color temperature of the lamp changes. The molybdenum coils function to prevent such a phenomenon.

Inside the main tube part 22, the luminous metals, a buffer gas, and a starting rare gas are enclosed. For example, mercury (Hg) is used as a buffer gas, and argon (Ar) is used as a starting rare gas. Moreover, as the luminous metals, dysprosium iodide (DyI₃), thulium iodide (TmI₃), holmium iodide (HoI₃), thallium iodide (T1I), and sodium iodide (NaI), respectively in a predetermined amount, are used.

The power supply part 34 extending from the thin tube part 32 is connected to the stem wire 15 (illustrated in FIG. 1), and the power supply part 44 extending from the thin tube part 42 is connected to the stem wire 14.

3. Operation of Metal Halide Lamp

When the electrode structures 31 and 41 receive voltage supply, the starting rare gas induces discharge between the electrodes. By this discharge, the temperature within the main tube part 22 will rise thereby vaporizing the luminous metals. The vaporized luminous metals are excited by colliding with the electrons, and emit emission spectrums. For example, sodium emits an emission spectrum having a color of yellowish orange and a wavelength between 589.0 nm and 589.6 nm (so called “D line”). Each luminous metal emits an emission spectrum of its own. Combination of emission spectrums for luminous metals defines a lamp's luminous flux, color temperature, and so on.

Here, an emission spectrum from an atom tends to be absorbed by other atoms of a same luminous metal, because an emission spectrum from a luminous metal atom has an energy amount sufficient and necessary for exciting other atoms of the same luminous metal. This phenomenon is known as “self-absorption”. If the self-absorption occurs too frequently, the amount of emission spectrums reaching outside the arc tube 20 will be reduced, leading to decrease in luminous efficiency.

So as to obtain a lamp having high luminous efficiency, self-absorption should be restrained as much as possible. In view of this, it is desirable that an emission spectrum does not collide against atoms of a same luminous metal and so is favorably transmitted outside the arc tube 20.

Meanwhile, an emission spectrum is emitted when an electron emitted by arc discharge collides with a luminous metal. Therefore, so as to heighten a lamp's luminous efficiency, it is preferable to increase the number of collision between electrons and luminous metals.

In view of the above-described two points, it is possible to obtain an arc tube with high luminous efficiency by making the main tube part 22 thin. Here, it has been confirmed that a high efficiency lamp is obtained if the relation of EL/Di≧2.0 is satisfied, where the distance between the electrode 31 and the electrode 41 is EL (mm), and the inner diameter of the main tube part 22 is Di (mm).

In addition, if the tube wall loading “WL” (W/cm²) of an arc tube is too small, it is impossible to obtain a sufficient amount of vapor pressure and so luminous efficiency is degraded. Therefore, it is necessary to set the tube wall loading to be at least 20 W/cm² or more. On the other hand, if the tube wall loading becomes too large, the temperature inside the main tube part 22 will be 1200° C. or more, raising the reactivity between the main tube part 22 and the enclosure. In such a case, erosion of the main tube part 22 might be caused. Therefore, it is necessary to set the tube wall loading to be 50 W/cm² or less.

In summary, a high efficiency lamp is obtained if EL/Di≧2.0 and 20≦WL≦50 are satisfied. Furthermore, it is confirmed that the self-absorption is reduced if the inner diameter Di of the main tube part 22 is set as 10 mm or less. However, it is practically difficult to set the inner diameter Di of the main tube part 22 to be less than 2.0 mm, from structural and manufacturing reasons. Therefore a practically preferable range of the inner diameter Di (mm) for the main tube part is 2.0≦Di≦10.0.

However, the arc tube 20 that satisfies the above-described conditions is slim and so the tube wall is closer to the arc than conventional cases. Therefore, the main tube part 22 will be heated to a higher temperature than in conventional cases, subjecting the main tube part 22 to a larger thermal shock. This causes a problem that a crack tends to happen even during the lifetime of the lamp.

The inventors of the present invention have conducted studies to find means for preventing such a crack, and then came to focus attention on the thermal characteristic of alumina used as a material of the main tube part 22. More specifically, the inventors have thought that if alumina gains improved resistance against the thermal shock, a crack can be prevented. After much trial and error, the inventors found that a crack is prevented if the diameter “G” of a crystal grain of alumina is adjusted to 5 μm or less (which is substantially smaller than the diameter of a crystal grain of alumina which is in a range of 15 μm to 40 μm). Further details are given later with reference to experimental data. First, a method of adjusting the diameter of a crystal grain of alumina as 5 μm or less is described as follows.

4. Method of Sintering Alumina

First, an overview of a sintering method is described. Alumina powders, a binder, and soon, are mixed to prepare slurry. Then, the prepared slurry is placed in a mold, and then is sintered at a predetermined temperature for a predetermined time. The alumina powders, being originally white, are crystallized by being sintered. As a result, sintering of translucent polycrystalline alumina ceramic, in which crystallographic axes have different directions from each other, completes. It is possible to obtain polycrystalline alumina ceramic having a desired grain diameter by adjusting a grain diameter of the alumina powders, a sintering temperature, and a sintering time. Hereinafter, polycrystalline alumina ceramic obtained in the above way is occasionally simply expressed as “alumina”.

Here, it is known that alumina powders undergo grain growth by being sintered. In view of this, in manufacturing of alumina having a grain diameter of 3 μm, for example, alumina powders having a grain diameter of about 0.5 μm are sintered.

When sintered, alumina powders sometimes cause so-called abnormal grain growth. Abnormal grain growth is a phenomenon in which a grain grows extremely large in some areas, impairing uniform grain growth. Abnormal grain growth tends to occur more as an alumina grain diameter gets smaller. In a conventional arc tube, alumina crystal grains have a diameter in a range of about 15 μm to 40 μm, but the present invention aims to obtain a smaller diameter of crystal grains than this range. Therefore abnormal grain growth tends to occur more in the present invention than in conventional cases. Once abnormal grain growth is caused, it becomes impossible to adjust a crystal grain diameter to a desired level. Therefore, it is essential to restrain the abnormal grain growth in the sintering process. The inventors have conceived two possible means for restraining the abnormal grain growth.

The abnormal grain growth occurs more frequently as the sintering temperature gets higher. In view of this, one means that the inventors have conceived for restraining the abnormal grain growth is to maintain the sintering temperature low. However, when alumina is sintered at low temperatures, the crystal density of the resulting alumina will not be sufficient. In other words, pores remain in the crystal grain boundaries. If the crystal grain boundaries contain pores, light transmitted through alumina will reflect diffusely, thereby degrading transmittance. In view of this, it is necessary to maintain the sintering temperature to such a level that can produce a sufficiently high crystal density. From the above reason, sintering at low temperatures is not inadequate.

The inventors have conceived another method for restraining abnormal grain growth. In this method, alumina is sintered with an additional substance. Here, it is confirmed that if alumina is mixed with magnesium oxide (MgO), and then sintered at high temperatures, abnormal grain growth is restrained and uniform grain growth is achieved. The following describes several aspects of sintering of alumina mixed with MgO.

First, a concrete method of sintering alumina is described. Conventionally, a hot isostatic pressing (hereinafter represented as “HIP”) is employed in sintering alumina having a comparatively small crystal grain diameter. In an HIP process, an object is heated while isotropic pressure is simultaneously applied. Normally, gas such as argon is used as a pressure medium. In addition, a so-called carbon furnace whose heating coil is made of carbon is used in sintering alumina.

Alumina powders are mixed with MgO, and are sintered using the same method as in the conventional HIP, to obtain alumina having a crystal grain diameter of 5 μm. The color of the sintered alumina is brownish or yellowish, which means that the alumina has low transmittance. The concrete reason for this transmittance reduction has not been examined, but possible causes are as follows. 1) Reduction in crystal grain diameter. 2) The sintering process was conducted under high pressure. 3) Addition of MgO. 4) Usage of a carbon furnace despite that alumina is easy to be impregnated with carbon. 5) Combination of any two of 1) to 4). Alumina having a brownish color does not have sufficient transmittance, and so is not adequate for use as a material of an arc tube.

The inventors of the present invention have studied on a sintering method with which alumina having high transmittance is obtained. After much trial and error, they found that when MgO-added alumina is sintered using a tungsten furnace, and at atmospheric pressure (i.e. in hydrogen atmosphere) or in a vacuum, resulting alumina will have a crystal grain diameter of 5 μm or less, translucent opal color, and transmittance of 94% or more.

5. Amount of MgO to be Added

Next, several arc tubes were experimentally produced using alumina, having been sintered in the above-described method, and so is translucent, has opal color, and has transmittance of 94% or more. Then a life test was conducted for lamps produced using these arc tubes. The test result shows that some of the lamps exhibit remarkably low luminous flux maintenance factors.

This phenomenon is attributable to high reactivity between added MgO and the enclosure in the corresponding lamps. In the polycrystalline alumina, MgO concentrates in the crystal grain boundaries. As the crystal grain diameter of alumina becomes smaller, the density of crystal grain boundaries is heightened, leading to increase in areas in which MgO and the enclosure are in contact as well as increase in reactivity therebetween.

When MgO and the enclosure react, the enclosure rare earth iodide and MgO are chemically bonded to generate a new compound such as magnesium iodide, thereby changing emission spectrums. In addition, it is confirmed that addition of MgO tends to cause the inner wall of the main tube part to be blackened, although the reason therefore has not been searched yet. These are considered the main reasons for the degrading of the luminous maintenance factor.

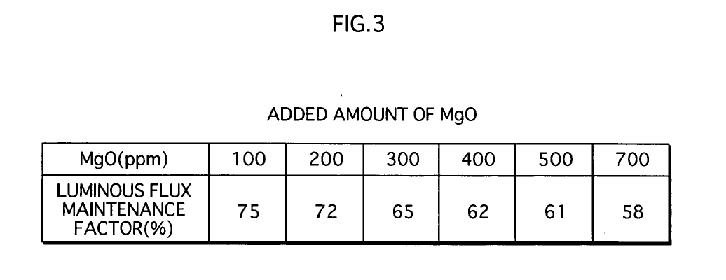

In view of the above, the inventors of the present invention, having realized the importance of the amount of MgO to be added, studied on the relationship between the luminous flux maintenance factor and the amount of MgO to be added. Specifically, the inventors experimentally produced various types of alumina arc tubes that vary in the amount of MgO added, and conducted a lighting test and measured change in luminous flux maintenance factor for the arc tubes. FIG. 3 shows a summary of the test results. FIG. 3 is actually data showing the relationship between the luminous flux maintenance factor and the amount of MgO added. A so-called life test was conducted as the lighting test. The life test was actually a repetition of a cycle of lighting a lamp for 5.5 hours and then extinguishing it for 0.5 hour. In the test, the crystal grain diameter G was maintained to 1.5 μm.

As FIG. 3 shows, in the case when the amount of MgO added is 300 ppm or more, the luminous flux maintenance factor falls below 70% when the lighting time has elapsed 12,000 hours. On the other hand, in the case when the added amount of MgO is 200 ppm or less, the luminous flux maintenance factor is kept to be 70% or more even after the lighting time has elapsed 12,000 hours. The result shows that restriction of the added amount of MgO to be 200 ppm or below restrains reaction between MgO and the enclosure, and so the resulting alumina is suitable for use as a material of a lamp's arc tube. It should be noted here that it is desirable to add at least 1 ppm of MgO, with a view toward restraining the abnormal grain growth.

In summary, it is revealed that if an arc tube is made of alumina obtained by sintering alumina that contains MgO of 200 ppm or below and at atmospheric pressure (i.e. in hydrogen atmosphere) or in a vacuum in a tungsten furnace, a resulting lamp will have low reactivity with the enclosure and a high luminous flux maintenance factor. In addition, if at least 1 ppm of MgO is added to alumina, a crystal grain diameter is adjusted to be small, and alumina of a high transmittance is obtained.

6. Size of Crystal Grain Diameter

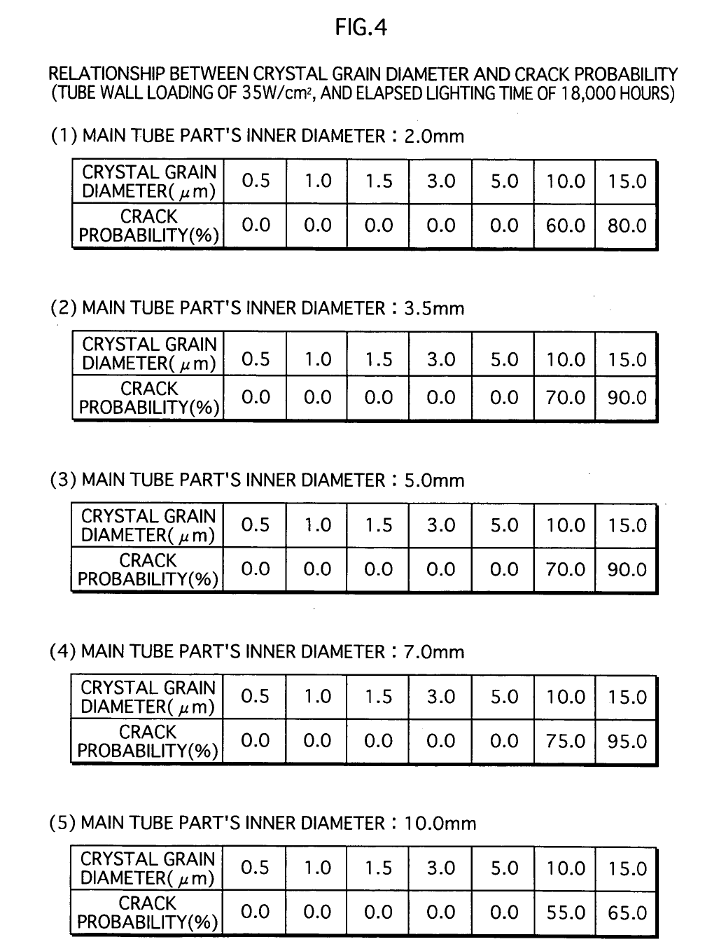

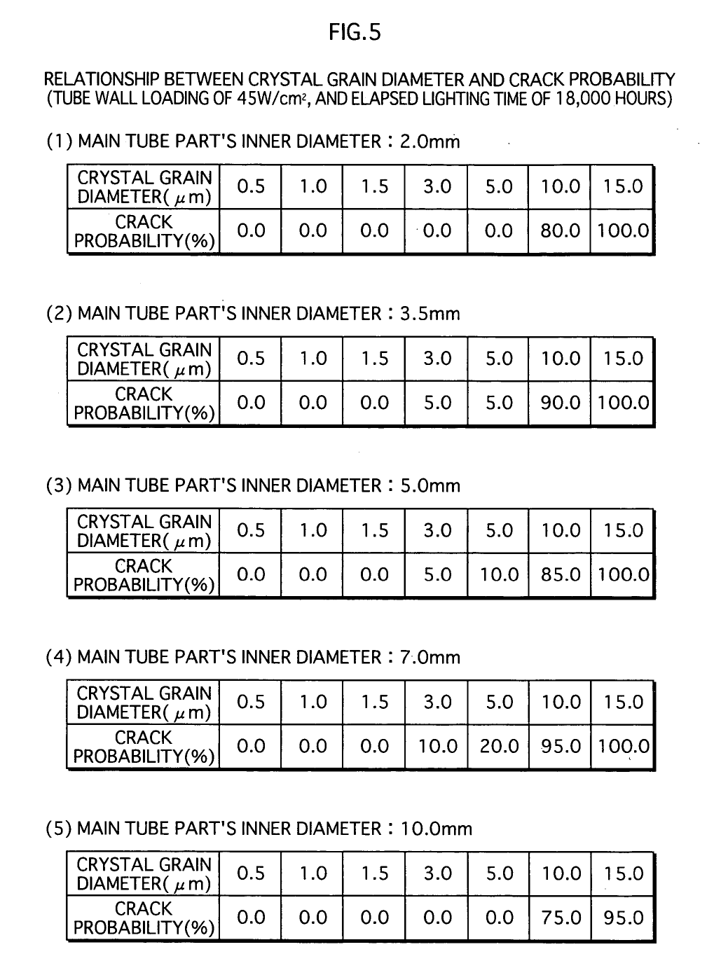

Using the method described above, alumina containing only 200 ppm of MgO and having a crystal grain diameter in a range of 0.5 μm to 15.0 μm was produced. Using the produced alumina, several types of arc tubes, varying in inner diameter Di of its main tube part from 2.0 mm to 10.0 mm, were produced. A lighting test was conducted using the arc tubes. Here, the crystal grain diameter was calculated by measuring the number of crystals per a unit length, and by dividing the unit length by the number of crystals. In the lighting test, the aforementioned life test was conducted for 18,000 hours. FIG. 4 and FIG. 5 show the test results. (1) to (5) respectively show data when the inner diameter Di of the main tube part is varied from 2.0 mm to 10.0 mm. Note that the tube wall loading was 35 W/cm² for the data of FIG. 4, and 45 W/cm² for the data of FIG. 5. In both FIG. 4 and FIG. 5, “crack probability” means a probability of generating a crack. Note that at rated life, if 50% or more of the lamps survive without cracking or the like (i.e. survival rate), the lamps will pass as a final product.

In the case where the tube wall loading is 35 W/cm² (FIG. 4), when the crystal grain diameter falls within the range of 0.5 μm to 5.0 μm, a crack does not occur whatever the size is for the inner diameter Di of the main tube part 22. On the contrary, when the crystal grain diameter is either 10.0 μm or 15.0 μm, the crack probability will be 55% or more, and the lamps cannot pass as a final product.

In the case where the tube wall loading is 45 W/cm² (FIG. 5), when the crystal grain diameter falls within the range of 0.5 μm to 1.5 μm, a crack does not occur whatever the size is for the inner diameter Di of the main tube part 22.

When the crystal grain diameter is 3.0 μm or 5.0 μm, a crack does not occur on condition that the inner diameter Di of the main tube part 22 is 2.0 mm or 10.0 mm. However, when the inner diameter Di is in the range of 3.5 mm to 7.0 mm, some arc tubes cracked. This is attributable to the fact that an arc will be bent due to buoyancy and so on when the inner diameter Di of the main tube part 22 becomes 3.5 mm or more. When the arc is bent, the arc will be closer to the inner wall of the main tube part 22 than before. Accordingly, the main tube part 22 will be locally heated to a high temperature, subjecting the main tube part 22 to a large thermal shock, and so the probability of generating a crack becomes large.

When the inner diameter Di of the main tube part 22 is 10 mm, the distance between the inner wall of the main tube part 22 and the arc is adequately maintained even when the arc is bent. Accordingly a crack did not occur.

When the inner diameter Di of the main tube part 22 is 2.0 mm, the bending of arc was not observed. The reason for this is considered that the inner diameter Di of the main tube part 22 is very narrow, so that the arc is subjected to a spacious constraint. Therefore, the arc, without being bent, is considered to have proceeded straight ahead.

When the inner diameter Di of the main tube part 22 is in the range of 3.0 mm to 7.0 mm, sometimes a crack was observed attributable to the bending of the arc mentioned above. However, the crack probability is only 20% or below, meaning that the survival rate is 80% or above. Therefore, it can be said that when the crystal grain diameter is 3.0 μm or 5.0 μm, the lamps will not have a problem as a final product.

In a conventional wide arc tube, the crystal grain diameter of alumina is substantially in a range of 15 μm to 40 μm. As shown in FIG. 4 and FIG. 5, when the crystal grain diameter is 15 μm, the crack probability will be 65% or more when the alumina is used for an arc tube having an inner diameter Di of 10 mm or below. As a result, the alumina cannot be used for a product. Moreover, when the crystal grain diameter is 10 μm, the crack probability is also high as 55% or more, meaning that the crack occurrence is not sufficiently reduced.

In summary, by setting the crystal grain diameter as 5.0 μm or below, the main tube part 22 is prevented from cracking, and the survival rate at 18,000 hours of lighting will reach 80% or above. In particular, it becomes clear that a crack is efficiently prevented when the crystal grain diameter is set as 1.5 μm or below, even under a severe temperature condition caused by bending of an arc, or the like.

In the above description, only the cases where the tube wall loading is 35 W/cm² or 45 W/cm² are described. However, the similar tendency was observed when the tube wall loading is in the range of 20 W/cm² to 50 W/cm². In addition, as the crystal grain diameter gets smaller, the resistance against a thermal shock will be heightened. In view of this, it is preferable to set the crystal grain diameter as small as possible. However, it is practically difficult to set the crystal grain diameter as 0.5 μm or below, from manufacturing reasons and also due to grain growth. As a result, a practically desirable range of the crystal grain diameter G (μm) is 0.5 μm to 5.0 μm, inclusive.

7. Lamp Characteristics

Alumina sintered using the above-described method is used to experimentally produce lamps (the alumna has a transmittance of 94.5%, a linear transmittance of 8%, a crystal grain diameter of 1.5 μm, and an added amount of MgO of 200 ppm). Then, other lamp characteristics are examined for the produced lamps.

Specifically, a life test was conducted under conditions below.

| | | |
|---|---|---|
| length of arc tube | 72 | mm |
| (distance between the thin tube | | |
| parts 32 and 42) | | |
| electrode length | 2.5 | mm |
| between-electrode distance EL | 32.0 | mm |
| inner diameter Di of the main | 4.0 | mm |
| tube part 22 | | |
| outer diameter φ of the main | 6.2 | mm |
| tube part 22 | | |
| arc tube configuration parameter EL/Di | 8.0 | |
| tube wall loading WL | 45 | W/cm² |

As a result, the lamps were proved to be highly efficient, exhibiting lamp efficiency of 1281 m/W, an average color temperature of 3025K, and an average color-rendering index Ra of 75. In addition, at the rated life, the lamps delivered a luminous flux maintenance factor of 85% when the lighting elapsed time is 9,000 hours, and no crack was observed in any of the main tube parts 22.

Another life test was also conducted under conditions below.

| | | |
|---|---|---|
| length of arc tube | 80 | mm |
| electrode length | 3.0 | mm |
| between-electrode distance EL | 40.0 | mm |
| inner diameter Di of the main | 4.0 | mm |
| tube part 22 | | |
| outer diameter φ of the main | 7.2 | mm |
| tube part 22 | | |
| arc tube configuration parameter EL/Di | 10.0 | |
| tube wall loading WL | 45 | W/cm² |

As a result, the lamps were proved to be also highly efficient, exhibiting lamp efficiency of 1341 m/W, an average color temperature of 3105K, and an average color-rendering index Ra of 78. In addition, at the rated life, the lamps delivered a luminous flux maintenance factor of 88% when the lighting elapsed time is 9,000 hours, and no crack was observed in any of the main tube parts 22.

As is clear from the above results, the present embodiment, by making a slim arc tube, enhances lamp efficiency as well as restrains occurrence of crack at the arc tubes. Therefore, the present embodiment is instrumental in providing a metal halide lamp having high efficiency and long life.

8. Modification Example

So far, the present invention has been described based on the embodiment. Needless to say, the present invention should not be limited to the concrete example shown in the above embodiment, and includes the following modification examples, for example.

In the above description, alumina has a small crystal grain diameter throughout the main tube part 22. However, a structure in which the crystal grain diameter is locally reduced is also possible. For example, in the case where the inner diameter Di of the main tube part 22 is 5 mm, sometimes the arc will be bent. This means that the central portion will be intensively heated. In this case, occurrence of a crack is restrained if the alumina's crystal grain diameter is adjusted to be 5.0 μm or below exclusively at the central portion of the main tube part 22 and its vicinity.

Furthermore, in the above description, a focus is given to the crystal grain diameter of alumina used as a material of the main tube part 22. However, alumina used as a material of the thin tube parts 32 and 42 may also be set as 5 μm or below. By doing so, a crack incident to thermal shock is also prevented at the thin tube parts 32 and 42.

Still further, in the above description, the main tube part 22 is described as having a substantially cylindrical tubular shape. Specifically, the main tube part 22 may be in a cylindrical tubular shape whose sectional form orthogonal to the tube axis is a circle having a same area everywhere. Alternatively, the main tube part 22 may be in a cylindrical tubular shape whose sectional form orthogonal to the tube axis is a circle whose area gradually increases as approaching the central portion of the tube (i.e. entasis shape).

Furthermore, in the above description, the main tube part 22 and the thin tube parts 32 and 42 are respectively independent parts, and the arc tube has a structure in which the thin tube parts 32 and 42 are inserted into the main tube part 22 to be sealed airtight by being fired. However, the arc tube may have a structure in which the main tube part 22 and the thin tube parts 32 and 42 are integrally formed into one piece.

### INDUSTRIAL APPLICABILITY

The present invention provides a slim arc tube that hardly cracks. Therefore, the present invention is instrumental in providing a metal halide lamp having a high efficiency and a long life.

1. A metal halide lamp comprising an arc tube that includes:
a pair of electrode structures, each of which has an electrode at a tip;
a main tube part made of polycrystalline alumina ceramic, and containing a discharge space in which the electrodes of the electrode structures are located to oppose each other; and
a pair of thin tube parts that connect from the main tube part and are sealed by respective sealing members with the electrode structures inserted therein, wherein
20≦WL≦50, EL/Di≧2.0, and 0.5≦G≦5.0 are satisfied, where tube wall loading of the arc tube is WL(W/cm²), a distance between the electrodes is EL(mm), an inner diameter of the main tube part is Di(mm), and a crystal grain diameter of the polycrystalline alumina ceramic is G(μm).

2. The metal halide lamp of claim 1, wherein the crystal grain diameter G(μm) of the polycrystalline alumina ceramic satisfies 0.5≦G≦1.5.

3. The metal halide lamp of claim 1, wherein the inner diameter Di(mm) of the main tube part satisfies 2.0≦Di≦10.0.

4. The metal halide lamp of claim 1, wherein the polycrystalline alumina ceramic contains magnesium oxide (MgO) of 200 ppm or below.

5. The metal halide lamp of claim 1, wherein the polycrystalline alumina ceramic has transmittance of 94% or more.
